(19) United States
(12) Patent Application Publication
(10) Pub. No.: US 2024/0016175 A1
(43) Pub. Date: Jan. 18, 2024

(54) COMPOSITIONS FOR COATING CHOCOLATE

(71) Applicant: Masterol Foods Pty. Ltd., Whitebridge (AU)

(72) Inventor: Nathan Kingsley CATER, Whitebridge (AU)

(21) Appl. No.: 18/036,770

(22) PCT Filed: Nov. 16, 2021
(86) PCT No.: PCT/AU2021/051358

§ 371 Date: May 12, 2023

(30) Foreign Application Priority Data
Nov. 16, 2020 (AU) 2020904220

(51) Int. Cl. A23G 1/54; A23P 20/10

(52) U.S. Cl. CPC A23G 1/54; A23P 20/11

(57) ABSTRACT

The present invention relates to compositions for coating a chocolate product, wherein the composition comprises a vegetable oil, water, a wax, one or more sugars and one or more additives selected from the group consisting of a humectant, an emulsifier, a starch or derivative thereof, an acidity regulator and a preservative. The present invention also relates to processes for producing the compositions.

### FIELD OF THE INVENTION

The present invention relates to compositions for coating chocolate and uses thereof. The present invention also relates to methods for producing compositions for coating chocolate.

### BACKGROUND

Products made of chocolate are consumed across the world and come in a variety of shapes, forms, and compositions. These chocolate products contain components such as cocoa mass, cocoa butter, milk and sugar, which results in a product having a physical profile defined by a relatively low melting point and limited resistance to physical deformation.

Chocolate products are often covered with at least one coating during or following the manufacturing process. Coatings for chocolate include polishes and varnishes. Polishes are applied prior to varnishes to give an initial shine as well as to protect the chocolate, and to ensure that any subsequent varnish coating does not mix or react with the underlying chocolate which would be undesirable since components of varnish may react with chocolate to form unwanted tastes and/or appearances. Varnishes may then be applied over the polish to give a desired aesthetic appearance to the chocolate product as well as to provide a moisture barrier. Having separate coatings requires separate manufacturing steps and processes.

These varnishes require a curing time typically between 8 and 12 hours before transport or storage so that individual chocolate pieces (commonly referred to as dragées) do not stick together. If undercured or otherwise allowed to contact each other, unaesthetically pleasing ‘kiss-marks’ can appear on the finished product.

These coatings may also assist to maintain the physical characteristics of the chocolate product, such as the product's aesthetics, taste and shape throughout the manufacture, transportation, storage and sale of these products. This is particularly important for chocolate products as it may be impossible to maintain tight control over the temperature and humidity conditions throughout the manufacture, storage, transportation and sale of these products.

Coatings for other food products, such as confectionery, jelly beans (soft sugar panning), chewing gum pellets and other hard sugar shelled products (hard sugar panning), jellies, gums and the like, are known, however there are a number of fundamental differences between confectionary and chocolate in terms of composition, taste and appearance which means that products suitable for confectionary are typically unsuitable for chocolate.

There remains a need for a coating composition for chocolate products that is suitable for use as a combination polish and varnish, where the composition can be applied more efficiently compared to existing separate coatings, without affecting the physical or aesthetic properties of the chocolate products.

### SUMMARY OF THE INVENTION

According to a first aspect, there is provided a composition for coating a chocolate product, wherein the composition comprises:
i) a vegetable oil;
ii) water
iii) a wax;
iv) one or more sugars; and
v) one or more additives selected from the group consisting of a humectant, an emulsifier, a starch or derivative thereof, an acidity regulator and a preservative.

In some embodiments, the composition comprises:
i) a vegetable oil present in an amount between about 5% to about 10%;
ii) water present in an amount between about 40% to about 50%;
iii) a wax present in an amount between about 1% to about 5%;
iv) one or more sugars present in an amount of at least about 30%; and
v) one or more additives selected from the group consisting of a humectant, an emulsifier, a starch or derivative thereof, an acidity regulator and a preservative.

In some embodiments, oil is present in an amount between about 5% to about 8%.

In some embodiments, the wax is present in an amount between 1% and 3%.

In some embodiments, the composition comprises a vegetable oil and water present in amounts to form an oil-in-water emulsion.

In some embodiments, the composition comprises at least one sugar or sugar substitute selected from: glucose solids, sucrose, isomalt, dextrin and sorbitol.

In some embodiments, the composition includes at least one humectant selected from invert syrup, glycerol, or dextrin.

In some embodiments, the composition includes invert syrup and maltodextrin.

In some embodiments, the invert syrup is present in an amount less than 8%.

In some embodiments, the composition comprises a wax selected from the group consisting of carnauba wax, candelilla wax, beeswax, paraffin and microcrystalline wax, or the wax is a hydrogenated palm stearine.

In some embodiments, the wax is carnauba wax.

In some embodiments, the composition comprises a preservative.

In some embodiments, the preservative is sodium benzoate and/or potassium sorbate.

In some embodiments, the composition further comprises an emulsifier with an HLB value less than 9.

In some embodiments, the composition further comprises an emulsifier selected from the group consisting of PGPR, mono- and di-glycerides of fatty acids, sucrose esters of fatty acids, lecithin, sorbitan esters and ethoxylated sorbitan esters.

In some embodiments, the composition has a pH of less than about 4.0.

In some embodiments, the composition further comprises ethanol or isopropanol.

In some embodiments, the composition is provided in the form of a liquid solution. In other embodiments, the composition is provided in the form of a powder.

According to a second aspect, there is provided the use of a composition according to the first aspect for coating a chocolate product.

According to a third aspect, there is provided a method for producing a composition for coating a chocolate product, the method comprising the steps of:
i) dissolving one or more sugars and one or more additives selected from the group consisting of a humectant, a water soluble emulsifier, a starch or a derivative thereof, an acidity regulator and a preservative in heated water to form a first mixture;
ii) adding a wax to a vegetable oil to form a second mixture;
iii) heating the second mixture;
iv) combining the first and second mixtures; and
v) homogenizing the resultant mixture to produce the composition under sufficient heat to prevent crystallization of the wax in the resultant mixture.

According to a fourth aspect, there is provided a method for producing a composition for coating a chocolate product, the method comprising the steps of:
i) dissolving one or more sugars and one or more additives selected from the group consisting of a humectant, a water soluble emulsifier, a starch or a derivative thereof, an acidity regulator and a preservative in heated water to form a first mixture;
ii) adding a wax to a vegetable oil to form a second mixture;
iii) heating the second mixture;
iv) combining the first and second mixtures; and
v) homogenizing the resultant mixture to produce the composition under sufficient heat to prevent crystallization of the wax in the resultant mixture;
vi) cooling the resultant mixture; and
vii) adding a solution of water and ethanol or isopropanol to the resultant mixture.

According to a fifth aspect, there is provided a method for producing a composition for coating a chocolate product, the method comprising the steps of:
i) dissolving one or more sugars and one or more additives selected from the group consisting of a humectant, a water soluble emulsifier, a starch or a derivative thereof, an acidity regulator and a preservative in heated water to form a first mixture;
ii) adding a wax to a vegetable oil to form a second mixture;
iii) heating the second mixture;
iv) combining the first and second mixtures; and
v) homogenizing the resultant mixture to produce the composition under sufficient heat to prevent crystallization of the wax in the resultant mixture;
vi) homogenizing the resultant mixture to under sufficient heat to prevent crystallization of the wax in the resultant mixture; and
vii) spray-drying the homogenized mixture to provide a composition in the form of a powder.

In some embodiments, a food acid is added to the first mixture to adjust a pH of the composition of less than about 4.0.

In some embodiments, an oil soluble emulsifier is added with the wax to the vegetable oil to form the second mixture.

In some embodiments, the method further comprises actively cooling the composition while agitating the composition following homogenization.

In some embodiments, the composition is actively cooled using a jacketed tank or a heat exchanger.

In some embodiments, the water is heated to between about 80° C. to 85° C. and the resultant mixture is homogenized at between about 80° C. to 85° C.

In some embodiments, the second mixture is heated to 90° C.

In some embodiments, the method is used to produce a composition according to the first aspect.

According to a sixth aspect, there is provided a method for coating a chocolate product, the method comprising applying to the chocolate product a composition as defined in the first aspect.

In some embodiments, the composition is applied to the chocolate product at a concentration of between about 1 ml to about 10 mL per 1 kg of chocolate product.

In some embodiments, the composition is applied to the chocolate product at a concentration of between about 1 mL to about 2 mL per 1 kg of chocolate product.

In some embodiments, the composition is applied to the chocolate product is applied at an ambient relative humidity of between about 30% and about 50%.

In some embodiments, the composition is applied to the chocolate is applied at an ambient temperature of between about 12° C. to about 20° C.

### BRIEF DESCRIPTION OF THE FIGURES

FIG. 1 shows a flow chart of a process for creating an embodiment of the invention.

FIG. 2 shows a comparison between a chocolate product coated with a conventional product (top) and a chocolate product coated with a composition of the present invention (bottom), where the chocolate product coated with the present compositions have far greater shine and gloss.

FIG. 3 shows the shine and gloss achieved when other chocolate products are coated with a composition of the present invention.

### DETAILED DESCRIPTION

The compositions as disclosed herein allow for the coating of chocolate products where the composition comprises an oil-in-water emulsion and a wax, a sugar and one or more additives selected from the group consisting of a humectant, an emulsifier, a starch or derivative thereof and a preservative. The compositions may be used as a combined polish and varnish for the exterior surface of the chocolate product, which requires application of an amount of the composition such that the exterior of the chocolate product is coated with the composition. Otherwise stated, the compositions as disclosed herein may be used as a coating for chocolate products that replaces and fulfils the function of both polish and varnish coatings. Upon drying of the composition, the exterior surface of the chocolate product achieves a shine. Although the aesthetic qualities of the chocolate product are important, the composition should also provide the necessary physical barrier between the chocolate surface and any other additional coatings that may be applied, as well as providing an effective moisture barrier between the environment and the chocolate product. The compositions may also assist in preventing or reducing the amount of scuff and kiss marks caused by rubbing of chocolate products with each other during curing, packaging, storage and transport.

The term “about” or “approximately” as used herein means within an acceptable error range for the particular value as determined by one of ordinary skill in the art, which will depend in part on how the value is measured or determined, i.e., the limitations of the measurement system.

Unless defined otherwise, all technical and scientific terms used herein have the same meaning as commonly understood by those of ordinary skill in the art to which the invention belongs. For the purposes of the present invention, the following terms are defined below.

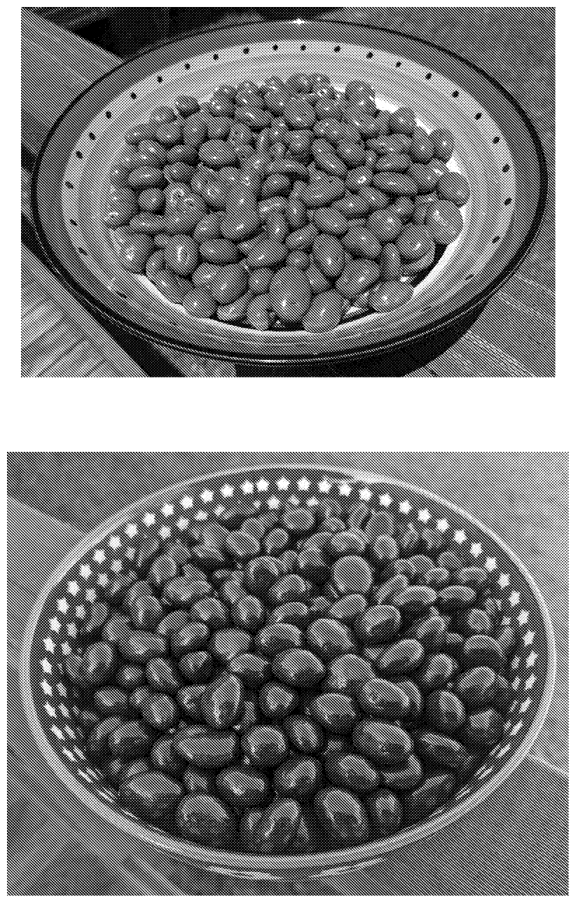

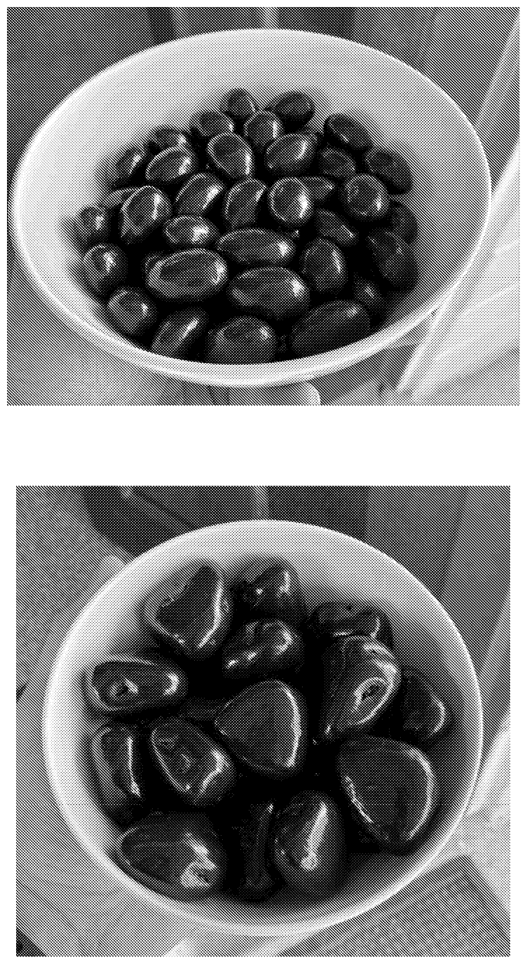

The present inventors have found that the composition disclosed herein, when applied to a chocolate product, provides a product that has greater resistance to heat when compared to an untreated product or a product treated with existing compositions. This means that a chocolate product treated with a composition as disclosed herein may withstand transport and storage to locations and climates having high temperature and/or humidity, without adversely affecting the quality of the product. Furthermore, the chocolate product coated with a composition as disclosed herein has greater shine and gloss when compared to chocolate products coated with existing compositions for the same purpose, as can be seen FIGS. 2 and 3.

A person skilled in the art would understand that the compositions disclosed contain several components and that stability of the overall composition is necessary. Given the nature of the components, for example, a vegetable oil, water and a wax, the compositions may require the addition of one or more other additives in order to provide a formulation that is suitable for use as described herein. For example, the various components should not react with one another in an adverse manner during storage and/or transport so as to reduce the effectiveness of the composition when applied to the surface of a chocolate product. The present inventors have found that the compositions as disclosed herein have the necessary stability during formulation, transport, storage and application. Furthermore, the compositions disclosed herein have the appropriate physical properties, for example viscosity and volatility, which allow for the composition to be applied to a chocolate product. The nature of the components and the amounts in which they are present provide a composition with the desired properties upon application and the necessary physical properties throughout the life of the composition.

An advantage of the present compositions as described herein is that the rate of application of the composition (i.e. the usage rate of the composition per unit of chocolate product) may be lower than other similar products. Further, as the composition acts as a combined polish and varnish, the amount of time required to coat the products can be reduced relative to existing polish and varnish coatings. Additionally, the 8 to 12 hour curing time typically associated with varnishes may be reduced or avoided using the present compositions.

A chocolate polish is typically used at a rate of between about 2 and 4 mL per kg of finished chocolate product. In the case of chocolate panning, a confectioner's varnish is typically used at a rate of between about 1 and 2 mL per kg of finished chocolate product.

In the case of the present invention, a concentration range of 1 to 1.5 mL per kg provides an effective barrier and offers a result comparable to a conventional polish and varnish system. Higher dosage rates, up to about 6 mL, 8 mL or 10 mL per kg of finished product, yield improved resistance to heat stress and scuff and kiss marks. In some embodiments, the composition is applied to the chocolate product at a concentration range of between about 1 mL to about 10 mL per 1 kg of chocolate product. In an embodiment, the composition is applied to the chocolate product at a concentration of about 1 mL per 1 kg of chocolate product. In an embodiment, the composition is applied to the chocolate product at a concentration of about 2 mL per 1 kg of chocolate product. In an embodiment, the composition is applied to the chocolate product at a concentration of about 3 mL per 1 kg of chocolate product. In an embodiment, the composition is applied to the chocolate product at a concentration of about 4 mL per 1 kg of chocolate product. In an embodiment, the composition is applied to the chocolate product at a concentration of about 5 mL per 1 kg of chocolate product. In an embodiment, the composition is applied to the chocolate product at a concentration of about 6 mL per 1 kg of chocolate product. In an embodiment, the composition is applied to the chocolate product at a concentration of about 7 mL per 1 kg of chocolate product. In an embodiment, the composition is applied to the chocolate product at a concentration of about 8 mL per 1 kg of chocolate product. In an embodiment, the composition is applied to the chocolate product at a concentration of about 9 mL per 1 kg of chocolate product. In an embodiment, the composition is applied to the chocolate product at a concentration of about 10 mL per 1 kg of chocolate product. The amount of the composition used may affect the resistance of coated chocolate product to heat, for example, a greater concentration of the applied composition allows for higher resistance of the coated chocolate product to heat.

It is commonplace in the process of chocolate panning to take up to 1 hour depending on manufacturing conditions and pan size. Under ideal conditions, the process may be completed in as little as 30 minutes. In contrast, at dosage rates of 1 to 2 mL per kg, the present invention yields improvements in panning times, with the panning process taking less than half as long as a conventional system—about 15 to 20 minutes. It will be understood that higher dosage rates of the compositions disclosed herein may require higher panning times.

Preferably, these coatings are applied to the chocolate product at an ambient humidity of between about 30% and about 50%, and at an ambient temperature of between about 12° C. to about 20° C.

Another advantage of the present composition is that it can be made vegetarian/vegan friendly as well as without alcohol where required, broadening the potential use of the composition on chocolate or chocolate-like products which are intended to be vegetarian, vegan, or alcohol free respectively. Furthermore, the compositions of the present invention may be produced without the use of alcohol, for example, as a solvent.

As used herein, the term “chocolate product” refers to a wide range of products typically containing cocoa solids and/or cocoa butter. The products may also contain sugar and milk solids, flavourings and other additives. The term “chocolate product” as used herein is not limited to, but intended to encompass milk chocolate, dark chocolate, white chocolate and other well known types of chocolate, as well as chocolate-like substitutes such as carob based chocolate substitutes and yoghurt style coatings.

The compositions as disclosed herein may be used as a combined polish and varnish for chocolate products. As used herein, the term “polish” in relation to chocolate products refers to a composition that may be applied to the surface of the chocolate product prior to application of a varnish and to any composition that is applied to chocolate product in order to provide an initial gloss and a barrier between the surface of the chocolate and any subsequent coatings, such as varnishes and other layers. The term “varnish” as used herein in relation to chocolate products refers to a composition which may be applied over the polish in order to give a desired aesthetic finish to the chocolate product.

The compositions for coating a chocolate product as disclosed herein comprise:
i) a vegetable oil;
ii) water
iii) a wax;
iv) one or more sugars; and
   one or more additives selected from the group consisting of a humectant, an emulsifier, a starch or derivative thereof, an acidity regulator and a preservative.

As used herein, the term “vegetable oil” refers to a mixture composed mainly of triglycerides extracted from a plant. The triglycerides of vegetable oil are typically fatty acid esters of glycerol. The plants from which a vegetable oil is extracted can include, but are not limited to, canola plants, soy plants, oilseed palms, coconut plants, and other plants containing such triglycerides and free acids. Preferred vegetable oils for the chocolate coating compositions include palm kernel oil, coconut oil and derivatives thereof such as medium-chain triglycerides (MCT) oil, for their high stability. In other embodiments, cocoa butter may be used.

In certain embodiments, the compositions of the present invention comprise a vegetable oil in an amount of between about 5% to about 10%. In some embodiments, the compositions comprise a vegetable oil in an amount of about 5%. In some embodiments, the compositions comprise a vegetable oil in an amount of about 6%. In some embodiments, the compositions comprise a vegetable oil in an amount of about 7%. In some embodiments, the compositions comprise a vegetable oil in an amount of about 8%. In some embodiments, the compositions comprise a vegetable oil in an amount of about 9%. In some embodiments, the compositions comprise a vegetable oil in an amount of about 10%.

As used herein, the term “wax” refers to a long chain hydrocarbon, typically aliphatic, that may or may not have one or more additional functional groups present. A wax may also contain various points of unsaturation and may be either animal-based, plant-based or petroleum-based. Esters of waxes are also included. Examples of waxes include carnauba wax, candelilla wax, jojoba oil, castor wax, beeswax, paraffin and microcrystalline wax. The term is also intended to refer to substances which behave like wax, for example, hydrogenated palm stearine.

In some embodiments, the wax may be present in the composition in an amount of between about 1% to about 5%. In certain embodiments, the wax is present in an amount of about 1%. In certain embodiments, the wax is present in an amount of about 2%. In certain embodiments, the wax is present in an amount of about 3%. In certain embodiments, the wax is present in an amount of about 4%. In certain embodiments, the wax is present in an amount of about 5%.

As used herein, the term “sugar” refers to a soluble carbohydrate such as glucose, fructose, sucrose, maltose or galactose which is used in cooking and food preparations for their sweet taste. The term is also intended to refer to sugar substitutes such as dextrin, isomalt, and polyols such as sorbitol. Sugars and sugar substitutes may be added to act a film former, which may also be referred to as a bulking agent in the context of glazing agents. In some embodiments, the film forming agent may take the form of a cellulose derivative such as Hypromellose (i.e. hydroxypropyl methyl cellulose, HPMC).

In some embodiments, the compositions disclosed herein comprise one or more sugars present in an amount of at least about 30%. In certain embodiments, the composition comprises one or more sugars in an amount of at least about 35%. In certain embodiments, the composition comprises one or more sugars in an amount of at least about 40%. In certain embodiments, the composition comprises one or more sugars in an amount of at least about 45%. In certain embodiments, the composition comprises one or more sugars in an amount of at least about 50%.

As used herein, the term “emulsifier” as used herein refers to a substance that promotes the formation of a stable emulsion by reducing the surface tension between components of a mixture. The term “emulsifier” may also refer to substances known as surfactants or surface-active agents, foaming agents, wetting agents or dispersants. Different emulsifiers may be classified according to their HLB (hydrophilic-lipophilic balance) value, which is a measure of the hydrophilicity or lipophilicity of the emulsifier and provides an indication as to the behaviour of the surfactant. For example, a surfactant with a low HLB value is predominantly hydrophobic and may be known as an antifoaming agent, while a surfactant with a moderate HLB value is less hydrophobic and may be known as a wetting agent. The emulsifier may be a monoester, diester, triester or higher polyester of a fatty acid, inorganic acid or combinations thereof. The emulsifier may be a sucrose ester of a fatty acid. The fatty acid may be monounsaturated, polyunsaturated or saturated. The ester of an inorganic acid may include phosphate esters, sulfate esters, borate esters and the like. Esters of other molecules such as saccharides or polyols are also included in this definition. These may include esters of glycerol, sorbitol, mannitol, xylitol, pentaerythritol and derivatives thereof. The esterification of the fatty acid, inorganic acid, saccharide or polyol may be complete or partial.

An emulsifier or a surfactant may be described as ionic or non-ionic. A wide range of ionic and non-ionic surfactants may be used for the emulsifier component. Non-ionic surfactants are preferred as they are readily available, of low toxicity and are cost effective. In an embodiment, the emulsifier is glycerol monooleate (GMO). In another embodiment, the emulsifier is sorbitan monooleate (SMO). In another embodiment, the emulsifier is polyglycerol polyricinoleate (PGPR). In another embodiment, the emulsifier is a lecithin, optionally a soy lecithin. In another embodiment, the emulsifier is an ethoxylated sorbitan monooleate. In another embodiment, the emulsifier is distilled monoglyceride (DMG). In a further embodiment, the emulsifier is polysorbate 60 (E435). In other embodiments, a mix of more than one emulsifier may be used. The present inventors have found that the use of an emulsifier or emulsifiers provides a composition as described herein that is homogenous and suitable for use as a coating for chocolate. In preferred embodiments, the emulsifier is lipophilic, that is to say that it has an HLB value below 9. In other embodiments, the composition comprises a mixture of emulsifiers that together provide an HLB value that is sufficiently high (or low) to achieve emulsification. A person skilled in the art would understand that the selection of an appropriate emulsifier will depend on the HLB value of a given emulsifier, the nature and amount of the other components in the composition and the overall desired properties of the compositions.

In certain embodiments, the pH of the composition may be adjusted below a pH level of 4. This may be achieved through the addition of a food acid, such as but not limited to citric acid or tartaric acid.

In certain embodiments, at least one starch or starch derivative (alternatively known as modified starches) may be added to the composition to fulfil the purpose of at least one of an emulsifier, emulsion stabilizer, film-forming agent, and/or bulking agent. Examples of starch derivatives which may be used include but are not limited to dextrin or maltodextrin. In some cases, the starch (for example dextrin) may also act as a humectant.

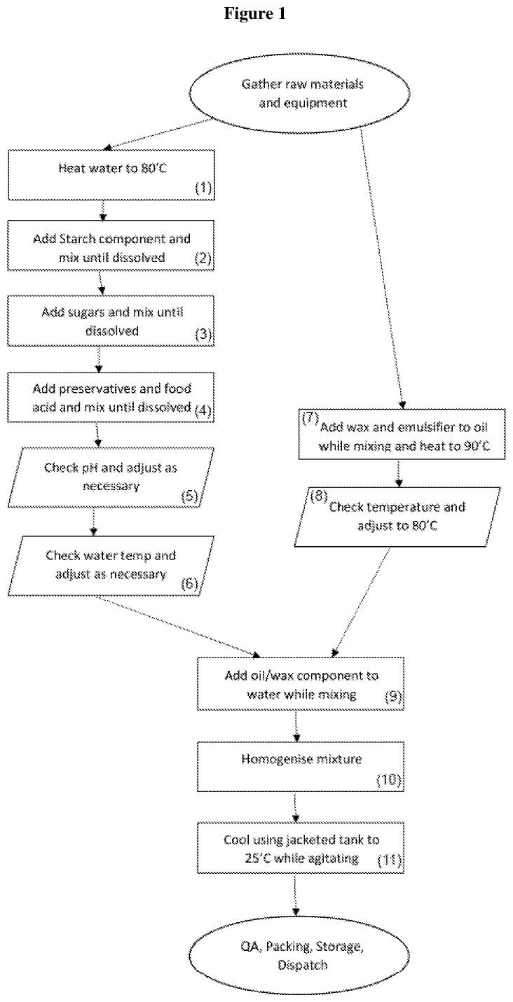

A flowchart showing a production process for an embodiment of the invention is shown in FIG. 1. Broadly speaking, the process consists of a water-based stream and an oil-based stream which are then combined and mixed together at heat and homogenized to form the composition for coating chocolate products.

In this embodiment, the water-based route consists of raising the temperature of the water to between about 80° C. to 85° C. (1), which has been chosen due to the high solubility of starches and sugars at this temperature. A starch component is added and mixed with the heated water until it is dissolved (2). Alternatively, the starch may be added to the water at ambient temperature and the mixture heated to achieve solubility of the starch. Following this, sugars are added and mixed into the water (3) and starch solution, before preservatives and food acid are added and mixed until dissolved (4). In this embodiment, the preservative is a combination of sodium benzoate and potassium sorbate, however it will be understood that in other embodiments, the preservative may be selected from other known preservatives, such as ethanol or isopropanol. At this point in time, the pH of the solution can be checked and adjusted if outside a desired range (5). For example, in this embodiment, the pH may be checked and more food acid added to bring the pH level below 4.

In this embodiment, the sugars, which are added as a humectant, may be in the form of an invert syrup. In other embodiments, other sugars, such as sucrose may be used. In sucrose including embodiments, the relative amount of sucrose added may be higher than the amount of invert syrup added in this embodiment. In further embodiments, polyols such as glycerol, starches such as dextrin or cellulose derivatives such as HPMC may also be added as a humectant, either in combination with other humectants or in place of them. In embodiments where invert syrup is used, the humectant properties of dextrins such as maltodextrin may be increased. Accordingly, the humectant properties of maltodextrin may be controlled by the amount of invert syrup added to the composition. This may be advantageous as control over the humectant properties can result in better shine and flexibility of the produced coating. In some embodiments, a combination of sugars may be added, such as maltodextrin and sucrose, which among other roles fulfil the purpose of a humectant. In these embodiments, a specific humectant additive may not need to be added to the composition.

In certain embodiments, invert syrup is present in the composition in an amount less than about 8%. In an embodiment, invert syrup is present in an amount of about 7%. In another embodiment, invert syrup is present in an amount of about 6%. In another embodiment, invert syrup is present in an amount of about 5%. In another embodiment, invert syrup is present in an amount of about 4%. In another embodiment, invert syrup is present in an amount of about 3%. In a further embodiment, invert syrup is present in an amount of about 2%.

In certain embodiments, maltodextrin is present in the composition in an amount between about 10% to about 50%. In an embodiment, maltodextrin is present in an amount of about 10%. In another embodiment, maltodextrin is present in an amount of about 15%. In another embodiment, maltodextrin is present in an amount of about 20%. In another embodiment, maltodextrin is present in an amount of about 25%. In another embodiment, maltodextrin is present in an amount of about 30%. In another embodiment, maltodextrin is present in an amount of about 35%. In another embodiment, maltodextrin is present in an amount of about 40%. In another embodiment, maltodextrin is present in an amount of about 45%. In another embodiment, maltodextrin is present in an amount of about 50%.

The starch component, which may be a modified starch such as dextrin is added to stabilize the emulsion in the finished coating. Other modified starches which may be used in other embodiments include but are not limited to modified starches with the codes E1400, E1401, E1402, E1403, E1404, E1405, E1410, E1411, E1412, E1413, E1414, E1420, E1420, E1421, E1423, E1430, E1440, E1441, E1442, E1443, E1450, E1451, and E1452 as coded by the International Numbering System for Food Additives. In preferred embodiments, the amount of modified starch added will be less than 3% of the total amount of the composition.

The food acid (such as tartaric acid) is added to the composition in order to bring the pH level of the composition below 4. This is important for maintaining emulsion stability. A low pH also is important for effectively controlling microbial activity, as preferred preservatives such as sodium benzoate and potassium sorbate are most effective at low pHs.

Further, the water temperature is checked and readjusted at this time (6). In embodiments where the mixture is held in an open tank, this stage may also involve measuring the net weight of the tank and adding water to account for any evaporation which has occurred. In other embodiments where a sealed tank is used, the net weight measurement may not be necessary.

The oil based stream consists of adding wax and an emulsifier to oil while mixing and then heating the mixture (7). In this embodiment, the mixture is heated to 90° C. The emulsifier added prior to heating may be a liquid emulsifier or alternatively a high melting point emulsifier. In preferred embodiments, the amount of added emulsifier is less than 1% of the total composition. Following this, the oil stream is brought to the same temperature as the water stream (8) and the two are mixed together (9). In this embodiment, the two streams are mixed together at a temperature between about 80° C. to 85° C., which has been chosen as it is higher than the melting point of carnauba wax, which is envisioned as the choice of wax in this embodiment. Accordingly, in other embodiments, the heating temperature may differ depending on the choice of wax and emulsifier, so long as the temperature is chosen to be not below the cloud point of any of the oil phase components in order to form the emulsion. For example, some emulsifiers such as lecithin are damaged at temperatures above ˜50° C., and would thus not be suitable in this embodiment.

It will be understood that the primary determinant of whether components of the composition are added to the water based stream or the oil based stream is their relative solubility. Accordingly, while in this embodiment an emulsifier is added to the oil based stream, in other embodiments, if a high HLB emulsifier is used, it may be added to the water based stream rather than the oil stream. In embodiments with cellulose or starch-based emulsifiers, for instance, these are dissolved in the water phase. In some embodiments, multiple emulsifiers are used with varying HLBs. Each emulsifier will be added to either the water based stream or oil based stream depending on their HLB.

The combined streams are mixed together (9) and then homogenized at heat (10). The inventors have found that the homogenizer must be utilized at the elevated temperature (in this embodiment, at between about 80° C. and 85° C.) to avoid even partial crystallization of the wax, which may cause the emulsion to fail. Otherwise stated, it is important to carry out high shear mixing and homogenization before allowing the product to crystallize in order to produce a stable emulsion. The homogenization step may be carried out through known methods, for example a colloid mill or a pressure homogenizer. In embodiments where a pressure homogenizer is used, the homogenization should be carried out between 1500 and 3500 psi (approx. 10.3 to 24.1 MPa), preferably between 2000 and 3000 psi (approx. 13.8 to 20.7 MPa).

Following this, the homogenized mixture is cooled to between about 20° C. and 30° C., preferably around 25° C. (11), where it is believed the majority of crystallization in the wax has occurred. In this embodiment, the composition is cooled with constant agitation in a jacketed tank. In other embodiments, other cooling methods may be used, for example a heat exchanger. In other embodiments, the product may be agitated without any active cooling. Further, it will be understood that in other embodiments, where crystallization has completed above 25° C., or is still occurring at 25° C., the composition may be cooled to a lesser or greater amount accordingly.

Where ethanol or isopropanol are present in the composition or used in the process for preparing the composition, the addition of ethanol or isopropanol to the mixture may cause the swelling of micelles present in the composition. This can be overcome by retaining a portion of the water to be used in the composition, blending the portion of water with the ethanol or isopropanol to be added and subsequently introducing this mixture to the composition as a final step. Since ethanol and isopropanol are volatile and evaporate at high temperatures, the resultant mixture must be cooled prior to the mixture of water and ethanol or isopropanol being added.

The homogenized mixture may be spray-dried under appropriate conditions to remove water present in the mixture and subsequently a composition in the form of a powder. The powder may be reconstituted prior to use with an appropriate amount of water to provide a composition in the form of a solution having the appropriate concentration for the uses discussed herein. The ability to provide a composition in the form of a powder allows for greater stability and longer shelf life, when compared to the composition in the form of a liquid or solution. Since the composition in the form of a liquid often means that the solution that remains unused may be subject to contamination and oxidation over time, providing a composition in the form of a powder where only the required amount is taken and reconstituted allows for additional stability of the composition over time. Furthermore, the compositions described herein when provided as a powder may find use in both soft- and hard-sugar panning applications to produce different types of products. Therefore in another embodiment, the methods disclosed herein also include a further step of spray-drying the composition to remove water and provide the composition in the form of a powder.

Throughout the specification the aim has been to describe the preferred embodiments of the invention without limiting the invention to any one embodiment or specific collection of features. Those of skill in the art will therefore appreciate that, in light of the instant disclosure, many modifications will be apparent to those skilled in the art without departing from the scope of the present invention.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

### EXAMPLES

The following examples are illustrative of the disclosure and should not be construed as limiting in any way the general nature of the disclosure of the description throughout this specification.

### Example 1—Composition Comprising Carnauba Wax

| Component | Amount |
|---|---|
| Glucose solids | 40% |
| Water | 46% |
| Humectant (Sugar) | 5% |
| Vegetable oil | 6% |
| Carnauba Wax | 2% |
| Emulsifier (e.g. PGPR, DMG, SMO) | <1% |
| Modified starch | <3% |
| Sodium benzoate and potassium | <0.3% |
| sorbate (as preservative) | |

### Example 2—Composition Comprising Carnauba Wax with Alternative Preservative

| Component | Amount |
|---|---|
| Glucose solids | 40% |
| Water | 41% |
| Humectant (Sugar) | 5% |
| Vegetable oil | 6% |
| Carnauba Wax | 2% |
| Emulsifier (e.g. PGPR, DMG, SMO) | <1% |
| Modified starch | <3% |
| Ethanol (as preservative) | 5% |

### Example 3—Composition Comprising Microcrystalline Wax

| Component | Amount |
|---|---|
| Glucose solids | 40% |
| Water | 46% |
| Humectant (Sugar) | <8% |
| Vegetable oil | <8% |
| Microcrystalline Wax | <3% |
| Emulsifier (e.g. PGPR, DMG, SMO) | <1% |
| Modified starch | <3% |
| Sodium benzoate and potassium | 0.3% |
| sorbate (as preservative) | |

### Example 4—Composition without Humectant

| Component | Amount |
|---|---|
| Glucose solids | 44% |
| Water | 41% |
| Vegetable oil | 8% |
| Carnauba Wax | 3% |
| Emulsifier (e.g. PGPR, DMG, SMO) | <1% |
| Modified starch | <3% |
| Sodium benzoate and potassium | <0.3% |
| sorbate (as preservative) | |

### Example 5—Composition Comprising Sucrose

| Component | Amount |
|---|---|
| Glucose solids | 22% |
| Sucrose | 22% |
| Water | 41% |
| Vegetable oil | 8% |
| Carnauba Wax | 3% |
| Emulsifier (e.g. PGPR, DMG, SMO) | <1% |
| Modified starch | <3% |
| Sodium benzoate and potassium | <0.3% |
| sorbate (as preservative) | |

In all examples in relation to the compositions disclosed herein, a food acid such as tartaric acid may be added to the composition in order to bring the pH level of the composition below 4. This is important for maintaining emulsion stability. A low pH also is important for effectively controlling microbial activity, as sodium benzoate and potassium sorbate are most effective at low pHs.

### Example 6—Coating of a Chocolate Product

The coating of a chocolate product with a composition as described herein can be achieved using standard chocolate panning equipment and conditions. The chocolate product to be varnished is added to the drum of the panning equipment. The composition for coating is then added to the chocolate with rotation of the drum and under various conditions of air-flow, temperature and humidity. Several doses of the composition (with a resting period in between each dose to ensure curing) may be used in order to achieve the desired film and gloss on the chocolate product. After addition of the final dose, the chocolate product is allowed to rest to ensure that curing is complete prior to packing of the finished product.

The claims defining the invention are as follows:

1. A composition for coating a chocolate product, wherein the composition comprises:
i) a vegetable oil;
ii) water
iii) a wax;
iv) one or more sugars; and
v) one or more additives selected from the group consisting of a humectant, an emulsifier, a starch or derivative thereof, an acidity regulator and a preservative.

2. A composition according to claim 1, wherein the composition comprises:
i) a vegetable oil present in an amount between about 5% to about 10%;
ii) water present in an amount between about 40% to about 50%;
iii) a wax present in an amount between about 1% to about 5%;
iv) one or more sugars present in an amount of at least about 30%; and
v) one or more additives selected from the group consisting of a humectant, an emulsifier, a starch or derivative thereof, an acidity regulator and a preservative.

3. A composition according to claim 2, wherein oil is present in an amount between about 5% to about 8%.

4. A composition according to claim 2 or 3, wherein the wax is present in an amount between 1% and 3%.

5. A composition according to any one of claims 1 to 4, wherein the composition comprises a vegetable oil and water present in amounts to form an oil-in-water emulsion.

6. A composition according to any one of claims 1 to 5, wherein the composition comprises at least one sugar or sugar substitute selected from: glucose solids, sucrose, isomalt, dextrin and sorbitol.

7. A composition according to any one of claims 1 to 5, wherein the composition includes at least one humectant selected from invert syrup, glycerol, or dextrin.

8. A composition according to claim 7, wherein the composition includes invert syrup and maltodextrin.

9. A composition according to claim 7 or 8, wherein the invert syrup is present in an amount less than 8%.

10. A composition according to any one of claims 1 to 9, wherein the composition comprises a wax selected from the group consisting of carnauba wax, candelilla wax, beeswax, paraffin and microcrystalline wax, or the wax is a hydrogenated palm stearine.

11. A composition according to claim 10, wherein the wax is carnauba wax.

12. A composition according to any one of claims 1 to 11, wherein the composition comprises a preservative.

13. A composition according to claim 12, wherein the preservative is sodium benzoate and/or potassium sorbate.

14. The composition according to any one of claims 1 to 13, wherein the composition further comprises an emulsifier with an HLB value less than 9.

15. A composition according to any one of claims 1 to 14, wherein the composition further comprises an emulsifier selected from the group consisting of PGPR, mono- and di-glycerides of fatty acids, sucrose esters of fatty acids, lecithin, sorbitan esters and ethoxylated sorbitan esters.

16. A composition according to any one of claims 1 to 15, wherein the composition has a pH of less than about 4.0.

17. A composition according to any one of claims 1 to 16, wherein the composition further comprises ethanol or isopropanol.

18. Use of a composition according to any one of claims 1 to 17 for coating a chocolate product.

19. A method for producing a composition for coating a chocolate product, the method comprising the steps of:
i) dissolving one or more sugars and one or more additives selected from the group consisting of a humectant, a water soluble emulsifier, a starch or a derivative thereof, an acidity regulator and a preservative in heated water to form a first mixture;
ii) adding a wax to a vegetable oil to form a second mixture;
iii) heating the second mixture;
iv) combining the first and second mixtures and homogenizing the resultant mixture to produce the composition under sufficient heat to prevent crystallization of the wax in the resultant mixture.

20. A method for producing a composition for coating a chocolate product, the method comprising the steps of:
i) dissolving one or more sugars and one or more additives selected from the group consisting of a humectant, a water soluble emulsifier, a starch or a derivative thereof, an acidity regulator and a preservative in heated water to form a first mixture;
ii) adding a wax to a vegetable oil to form a second mixture;
iii) heating the second mixture;
iv) combining the first and second mixtures; and
v) homogenizing the resultant mixture to produce the composition under sufficient heat to prevent crystallization of the wax in the resultant mixture;
vi) cooling the resultant mixture; and
vii) adding a solution of water and ethanol or isopropanol to the resultant mixture.

21. A method for producing a composition for coating a chocolate product, the method comprising the steps of:
i) dissolving one or more sugars and one or more additives selected from the group consisting of a humectant, a water soluble emulsifier, a starch or a derivative thereof, an acidity regulator and a preservative in heated water to form a first mixture;
ii) adding a wax to a vegetable oil to form a second mixture;
iii) heating the second mixture;
iv) combining the first and second mixtures; and
v) homogenizing the resultant mixture to produce the composition under sufficient heat to prevent crystallization of the wax in the resultant mixture;
vi) homogenizing the resultant mixture to under sufficient heat to prevent crystallization of the wax in the resultant mixture; and
vii) spray-drying the homogenized mixture to provide a composition in the form of a powder.

22. A method according to any one of claims 19 to 21, wherein a food acid is added to the first mixture to adjust a pH of the composition of less than about 4.0.

23. A method according to any one of claims 18 to 22, wherein an oil soluble emulsifier is added with the wax to the vegetable oil to form the second mixture.

24. A method according to any one of claims 18 to 23, further comprising actively cooling while agitating the composition following homogenization.

25. A method according to claim 24, wherein the composition is actively cooled using a jacketed tank or a heat exchanger.

26. A method according to any one of claims 19 to 25, wherein the water is heated to between about 80° C. to 85° C. and the resultant mixture is homogenized at between about 80° C. to 85° C.

27. A method according to any one of claims 19 to 26, wherein the second mixture is heated to 90° C.

28. A method according to any one of claims 19 to 27 used to produce a composition according to any one of claims 1 to 17.

29. A method for coating a chocolate product, the method comprising applying to the chocolate product a composition as defined in any one of claims 1 to 17.

30. A method according to claim 29, wherein the composition is applied to the chocolate product at a concentration of between about 1 ml to about 10 mL per 1 kg of chocolate product.

31. A method according to claim 31, wherein the composition is applied to the chocolate product at a concentration of between about 1 mL to about 2 mL per 1 kg of chocolate product.

32. A method according to any one of claims 29 to 31, wherein the composition is applied to the chocolate product is applied at an ambient relative humidity of between about 30% and about 50%.

33. A method according to any one of claims 29 to 32, wherein the composition applied to the chocolate is applied at an ambient temperature of between about 12° C. to about 20° C.
